(19) United States
(12) Patent Application Publication
(10) Pub. No.: US 2016/0026898 A1
(43) Pub. Date: Jan. 28, 2016

(54) METHOD AND SYSTEM FOR OBJECT DETECTION WITH MULTI-SCALE SINGLE PASS SLIDING WINDOW HOG LINEAR SVM CLASSIFIERS

(71) Applicant: AGT International GmbH, Zurich (CH)

(72) Inventors: Pablo Abad, Schweinfurt (DE); Stephan Krauss, Kaiserslautern (DE); Jan Hirzel, Kaiserslautern (DE); Didier Stricker, Kaiserslautern (DE); Henning Hamer, Darmstadt (DE); Markus Schlattmann, Darmstadt (DE)

(21) Appl. No.: 14/807,622

(22) Filed: Jul. 23, 2015

Related U.S. Application Data
(60) Provisional application No. 62/028,667, filed on Jul. 24, 2014.

(51) Int. Cl. G06K 9/62; G06T 7/20; G06T 7/60; G06K 9/52; G06F 17/30; G06K 9/46

(52) U.S. Cl. CPC G06K 9/6256; G06F 17/3079; G06K 9/6267; G06K 9/4642; G06T 7/60; G06K 9/52; G06T 7/2033; G06T 2207/30252; G06T 2207/20021; G06K 2009/4666

(57) ABSTRACT

The invention provides methods and systems for reliably detecting objects in a received video stream from a camera. Objects are selected and a bound around selected objects is calculated and displayed. Bounded objects can be tracked. Bounding is performed by using Histogram of Oriented Gradients and linear Support Vector Machine classifiers.

### CROSS REFERENCE TO RELATED APPLICATIONS

This application claims the benefit of U.S. Ser. No. 62/028,667, filed on Jul. 24, 2014, which is incorporated in its entirety herein by reference.

### FIELD OF THE INVENTION

The invention relates generally to systems and methods for video analytics, traffic management and surveillance. Specifically, the invention relates to use of video analytics for traffic management and surveillance activities and operations.

### BACKGROUND OF THE INVENTION

Initialization of a video-based object tracking system may be required. In a real time system in which an operator may be watching a live stream, and may want to start visual tracking of an object, such as a vehicle, instantly an option of pausing the video to allow the operator to define an exact bounding box of the vehicle to track may be problematic, as this may consume a lot of time and may be heavily dependent on the individual operator's skills. This may result in the system being unusable in practice.

### SUMMARY OF THE INVENTION

A multi-scale single pass sliding window Histogram of Oriented Gradients (HOG) linear Support Vector Machine (SVM) classifier, that may be trained offline, for example with samples of fixed real world size objects may be used. In some embodiments faster speed of acquisition and/or selection may be desired for real-time applications, so calibration information may be used to skip multi-scale search and thus speed-up the detection. Calibration information may be pre-determined and/or pre-stored. An embodiment may be reliable, and may sometimes be a relatively slower algorithm with respect to reliability. An embodiment may be a technique to allow detecting reliably an object in a video frame, as well as identifying its size in real-time from a video input, for example from calibrated cameras.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an exemplary diagram according to embodiments of the present invention;

FIG. 2 depicts an exemplary diagram according to embodiments of the present invention;

FIG. 3 depicts an exemplary diagram according to embodiments of the present invention;

FIG. 4 depicts an exemplary diagram according to embodiments of the present invention;

FIG. 5 depicts an exemplary diagram according to embodiments of the present invention;

FIG. 6 depicts an exemplary diagram according to embodiments of the present invention;

FIG. 7 depicts an exemplary diagram illustrating components according to embodiments of the present invention; and

FIG. 8 depicts an exemplary method according to an embodiment of the present invention.

Embodiments of the invention are illustrated by way of example and not limitation in the figures of the accompanying drawings, in which like reference numerals indicate corresponding, analogous or similar elements. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A problem that may be addressed by an embodiment may be the initialization of a video-based, or visually-based, object tracking system. To initialize tracking of a specific object, a visual tracking algorithm may need user input, e.g. initialization input, to start. Initialization input may be a bounding rectangle of an object in captured images, e.g. a video, at a certain time. Such a rectangle may mark a visual bound in, for example, one video frame, of the object which may be going to be tracked for subsequent frames. An object may be a vehicle. Other shapes may be used for bounding.

In a system, such as a real time system, in which an operator may be watching a live video stream and may want to start visual tracking of an object, such as a vehicle, relatively instantly, limited input may be expected from the operator to start the tracking due to the timing constraints. An option of pausing the video to allow the operator to define a precise bounding box, or outline, of a vehicle to track may be problematic, since it may consume additional time and may be dependent on an individual operator's skills. In certain circumstances, such a system may be cumbersome, or in an extreme case, unusable in practice.

An embodiment may be to allow an operator to start visual tracking, for example, with a single input, e.g. a mouse click. Such an input may be situated such that it may be on top of an object, or even only close to an object that may appear in at least one frame of the video stream.

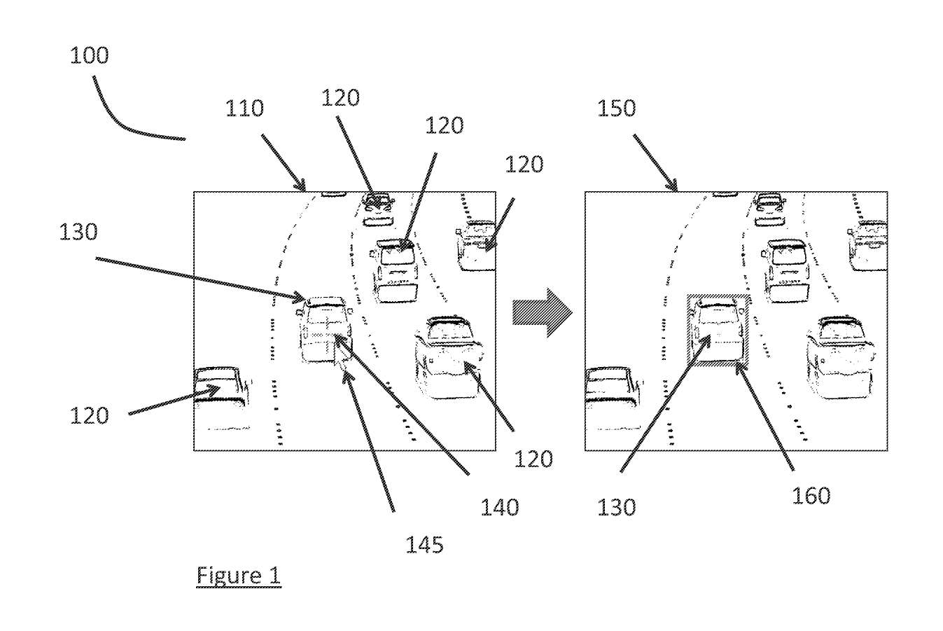

Reference is made to FIG. 1. An operator may be viewing a video stream 100, which may be delivered to the operator via a display unit. One or more frames 110 of the video stream may be visible. Within such a visible frame 110 may be an object, e.g. a vehicle, of interest 130. Other objects 120 may also be visible within frame 110. An operator may use an input unit, e.g. a computer mouse or other peripheral, to position a user controlled graphic 145 over, or within a predetermined proximity of target object 130. A user may apply an input via the mouse and a target graphic 140 may be displayed within any current or subsequent frame 110. Target graphic 140 may track from user controlled graphic 145 input, and may move around frame 110 according to user controlled graphic 145, e.g. based on a predetermined distance from user controlled graphic 145. Target graphic 140 may overlay geographic features, e.g. centers, of objects 120, 130, for example nearest to selection graphic 145. Following selection and placement of target graphic 140 a selection area graphic 160, e.g. a rectangular box graphic, may be placed around target object 130. Frame 150 which displays selection area graphic 160 may be the same frame 110 or a subsequent frame. Selection area graphic 160 may be any suitable shape. Selection area graphic 160 may be located by a computing unit operably connected to a display unit. Selection area graphic 160 may be placed automatically, and may be based on target graphic 140.

A user input, e.g. a mouse click, may be converted into a bounding box around an object, e.g. a fully enclosing bounding box, which may be used to initialize a visual tracking algorithm. It may be required to correctly and reliably detect an object within a close proximity around, for example the mouse click. Inaccuracies in a position of an operator clicking location may also be allowed for and taken into account. A size of an object may also be identified. Such detection may be real-time capable, and may alleviate problems, for example when selecting a bounding box manually. In an embodiment, a real-time requirement may mean detection may be done quickly, e.g. in under 50 milliseconds, when, for example a targeted video stream may not be less than 20 frames per second (fps).

Many detectors may be available which may be able to identify an object and/or its size, for example on an image. Some detectors may be slow when running under a real-time requirement, and others may be of questionable reliability. Detection algorithms may not have information about a size and/or orientation of objects that may be in an image. Such algorithms may be run at different scales and/or rotations, and may make a detection process with minimal or no scalability, or difficult to run in real-time.

In an embodiment it may be assumed calibration parameters, e.g. defining a mapping between two-dimensional (2D) pixel coordinates and three-dimensional (3D) street coordinates, of cameras to be known or predetermined, for example for videos to process. Image space coordinates and/or distances may then be converted, for example into real world coordinates and/or distances.

In an embodiment, a solution may be based on use of a multi-scale single pass sliding window Histogram of Oriented Gradients (HOG) linear Support Vector Machine (SVM) classifier, that may be trained offline, for example with samples of a fixed real world size. In some embodiments such a method may not be fast enough for real-time applications, so calibration information may be used to skip multi-scale search and speed-up the detection. An alternate method may operate with an otherwise very reliable, but relatively slow algorithm. An embodiment may be a technique to allow detecting reliably an object in a video frame, as well as identifying its size in real-time from video input, for example from calibrated cameras.

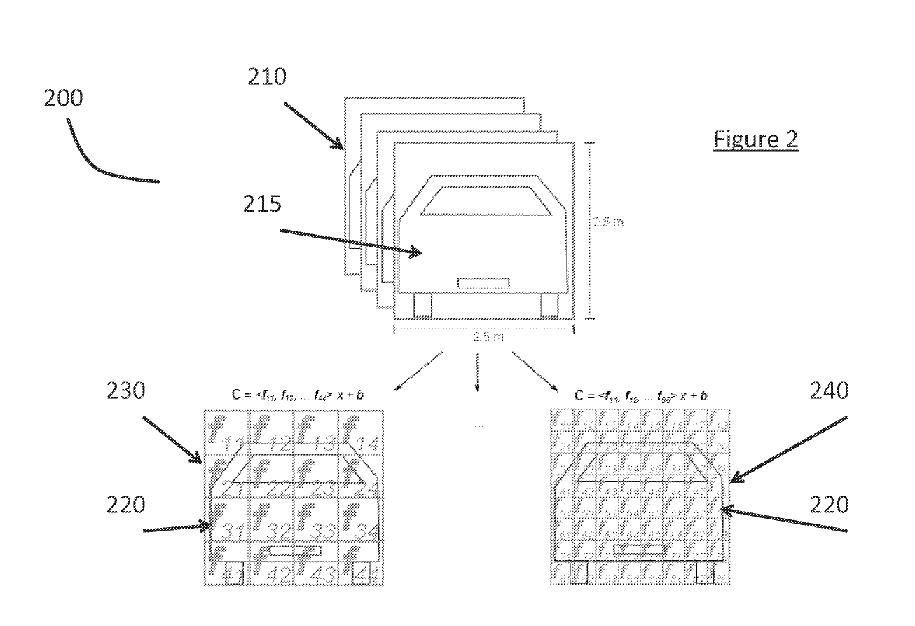

A method according to an embodiment may be as follows, and with reference to FIG. 2. One or more object classifiers for the same object or object category, or other such designation, may be trained and/or pre-determined. Different grid sizes may be trained. A linear HOG classifier may be a linear classifier which works on HOG feature vectors. HOG features may be calculated by dividing an image, for example into a grid, as depicted 200 by an exemplary embodiment. One or more images 210 may be captured by a camera, or other sensor. An image 215 may be used as a training image, and may be oriented for such purpose, for example perpendicular to a direction of travel of the vehicle. For each of the cells 220 of a grid 230, 240 a fixed size HOG descriptor vector may be calculated. A final HOG descriptor may be obtained by concatenating row by row HOG descriptors of individual cells. A linear classifier may be trained, for example, with positive and negative HOG feature vectors samples which may be extracted from several image samples. A linear SVM classifier, or other classifier, may be used. Linear SVMs may be trained for several grid 230, 240 sizes, for example 8×8, 9×9 . . . 16×16, etc., on the same set of images 210, 220. Such images may have the same real world dimensions. For example, for a car, detector classifiers may be trained with images of an imaginary square 220, e.g. of 2.5 m×2.5 m, which may be “hanging” from the back of a vehicle, perpendicular to the ground. Such a square may be independent from the vehicle size. This training step may be performed offline, or may be predetermined.

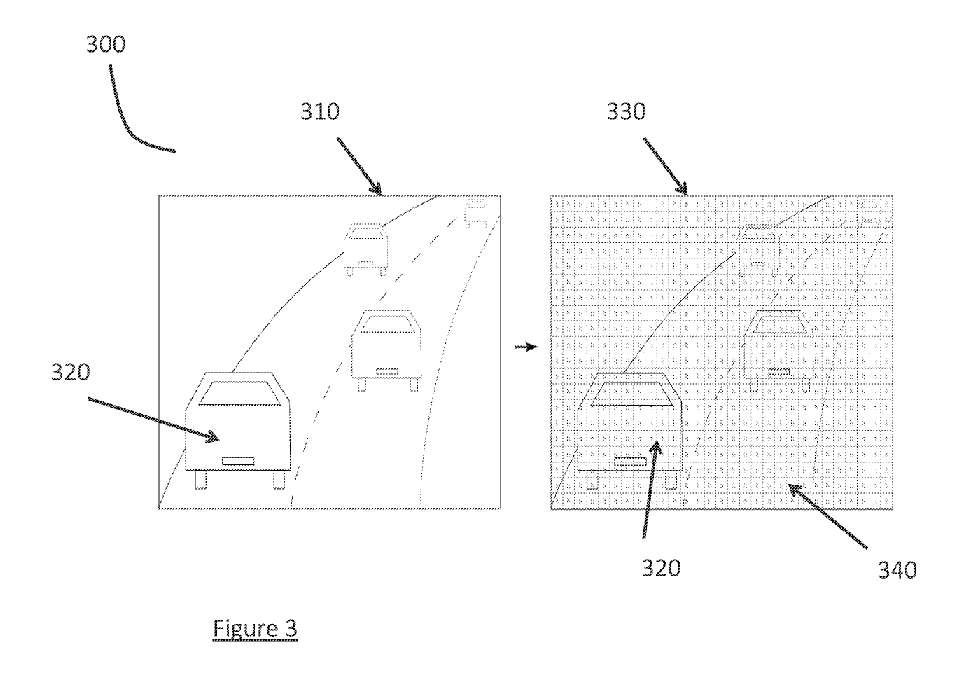

Reference is made to FIG. 3, where images received are depicted 300. For each of the images 310 on which detection may be performed, roll may be first corrected, for example by rotating the image such that the ground plane is parallel to the horizontal orientation of the image.

Calculations may be simplified by such rotation. Within such image are objects 320 to be detected. The image may be divided 330 into cells 340 that may be of fixed pixel dimensions. For each cell, HOG features may be calculated. Such a calculation may be performed efficiently, for example by a graphics processing unit (GPU) with compute unified device architecture (CUDA).

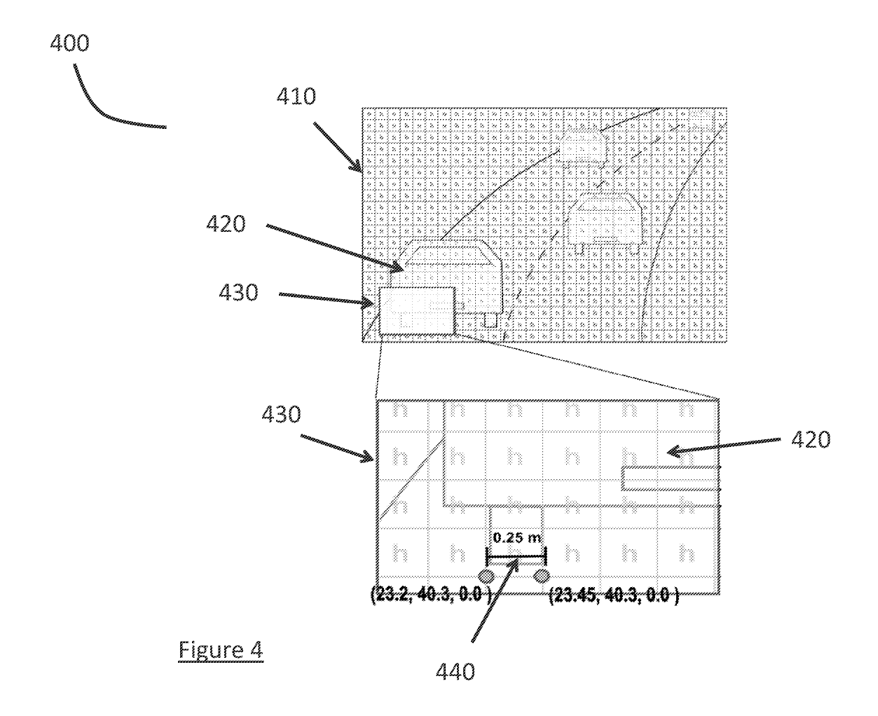

Reference is made to FIG. 4, where divided images are depicted 400. An image 410, containing objects 420 of interest, which is divided into cells, e.g. by a grid, may be analysed. Plane patches 430 that may be used to detect, e.g. objects, may be parallel to the camera plane. Perspective effects of some patches 430 that may be very close patches 430 may be ignored. Each of the cells in the same row as the same size real world patches 430 may be considered. The real world size of each cell may be calculated by calculating the position in 3D world coordinates, e.g. of the bottom left and bottom right points in each cell, considering their back projection may be on the scene ground plane, and calculating the Euclidean distance between them 440.

Then, a size of a grid in cells per each row may be calculated which may correspond to the real world size of the patches 430 that the classifiers may be trained with, e.g. 2.5 m, rounding to the nearest grid size in some cases. Such calculation may be performed according to:

Grid side (in cells)=Round(Real world train patch size/Calculated row's cell width)

Using such information a desired grid size may be pre-calculated to detect objects, e.g. vehicles, in each of the rows.

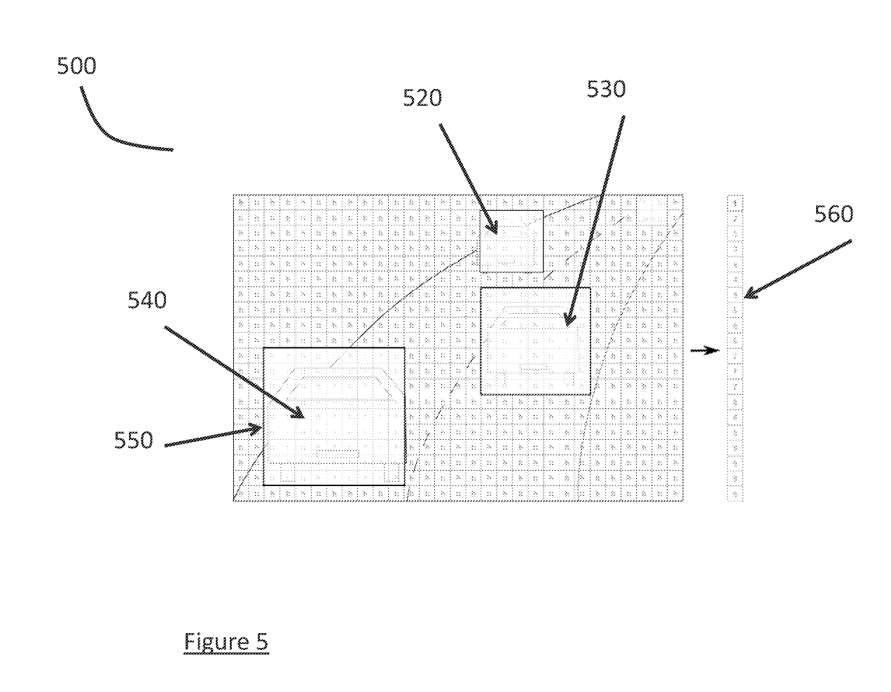

Reference is made to FIG. 5, where divided images and a grid are depicted 500. An image containing objects 520, 530, 540 of interest is analysed. A sliding window detection using a different window size 560 for each of the rows is performed. A different classifier may be used, and a selection of a classifier may depend on a window 550 size. Such detection may be parallelizable, as the calculation for each cell of the grid may be done independently in some embodiments. Making use of this consideration, a parallel Compute Unified Device Architecture (CUDA) kernel may calculate classifiers' responses in each of the cells. Maxima suppression, or other appropriate techniques, may be used to determine final detections. The size of such detection at each cell may come from, for example, the detection grid size used in the cell.

In an embodiment, speed of detection and/or acquisition may be increased. An increase of such speed may be from consideration of the perspective of one or more cameras. In an image, sizes of classifiers may vary, for example at one area of the image 500, e.g. 32×32 grids may be needed around an object 540 and another area of the image 500, e.g. 6×6 grids may be needed around an object 530. An image may be divided, according to methods described herein into several parts, and may depend on sizes of classifiers for which training may have been done. An image 500 may be divided into a plurality of grids, each of the same or different grids sizes.

Dividing an image may be done by various methods, for example by line scanning the image. Line scanning may be done, for example, from the bottom of the image to the top of the image, or in another order. Lines which may have been scanned may be compared to sizes of classifiers, where classifiers may be pre-determined and/or stored, for example in a memory, and may be trained classifiers. Comparisons may be performed by a processor or other computing device.

In some embodiments, a scanned line may have a grid size which may be bigger than a maximum size of a trained classifier, and such image part may be reduced. Lines on top of a first one for which a classifier may have been trained, e.g. given a current part scaling, may fit into a scaled part. Such process may be continued until the image may be divided into regions. In each such region, an algorithm, for example as described herein, may be used.

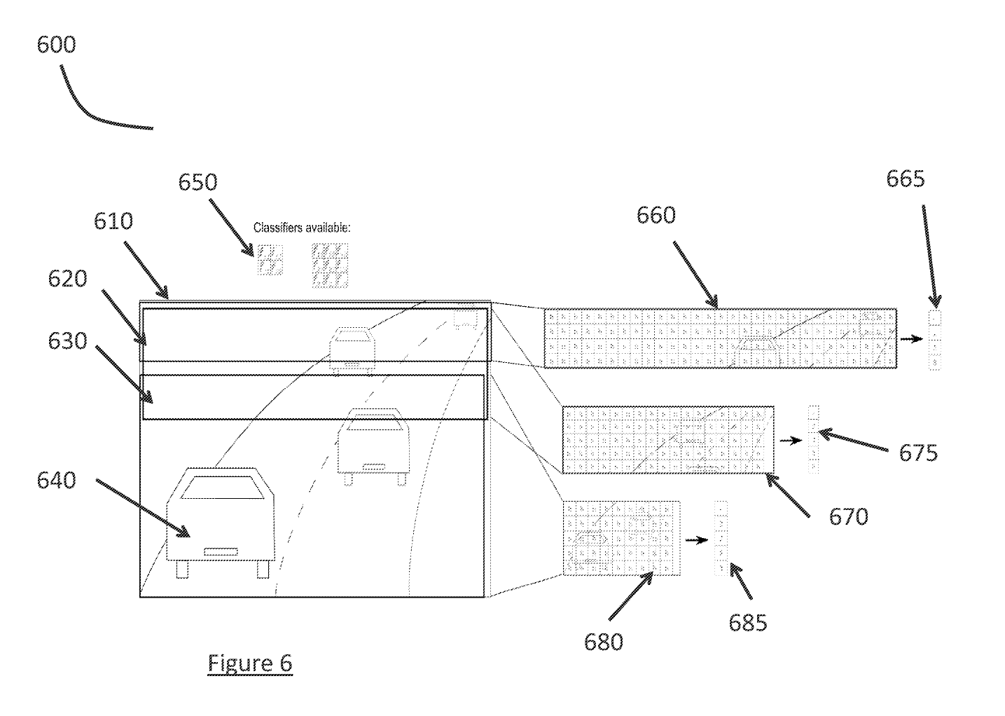

Reference is made to FIG. 6, a depiction of an image undergoing line scanning 600. An image 610 may be received that may contain objects 640 to be identified and/or selected. An image 610 may be divided into grids 680, and each grid 685 may be analyzed. It may be determined such image 610 may be line scanned, and scan lines 620, 630 may be identified and/or determined, for example by an algorithm designed to perform line scanning. Lines 620, 630 may be further scaled and subdivided into grids 660, 670, where each grid may be analyzed using a sliding window detection with different window sizes 665, 675 for each row, as in FIG. 5. Classifiers 650 may be predetermined and/or stored, and windows of sizes 665, 675, 685 for each row may be compared to classifiers 650. Results of such comparisons may be used to identify and/or select objects within image 610.

Other embodiments may use GPUs to increase speed of HOG detectors and may have been developed such that implementations of such detectors may be available. Such implementations may make less use of a camera calibration and may detect using several scales. Use of a camera calibration and/or ground plane in order to improve detections may be used, and may be a way to prune detections that, for example, may not agree with geometric constraints in a scene.

Other embodiments may speed up detections according to scene geometry and/or related constraints. Regions may be calculated in an image for which a detector of specific pixel size may be able to detect objects within certain ranges of real world sizes. Such a technique may divide an image into several parts. Each part may then be resized, its HOG calculated, and a sliding windows classifier of a specific pixel size may be applied to each part. Generating many parts with overlapping contents, resizing them and calculating HOGs for each part, may increase processing time, and thus may be included. In cases where a minimal set of parts needed to cover the entire image may not be automatically determined, as such may need as input the number of scales that may be desired to be used, additional considerations and/or algorithms may be made and included.

Embodiments may include speeding up detections given scene geometry constraints. Although it may be desirable for a number of scale levels to be explicitly given, the present invention does not need to explicitly specify the number of scales.

It may be desirable for a scale operation to be performed for each region, however, no scaling needs to be done, except, for example, when using an additional technique to work when sizes of classifiers may be limited.

HOGs may be calculated for each region, which may sometimes imply recalculation in overlapping regions, however, although not required, this may not be desirable.

A detector may be trained according to a specific size, however, detectors may also be trained according to several sizes, one or more sizes and/or a plurality of sizes.

Some embodiments may not impose any grid detection, making each more general. Such detection may disallow a performance improvement which may be exploited, for example by calculating a HOG grid per image.

Some embodiments may be a method for performing a previous and/or pre-determined division of an image such that it may work when sizes of linear classifiers may be limited. This can be seen as an extension for more than one detector size.

Some embodiments may use methods described herein to reduce the number of trained classifier sizes. Such reduction may not be a requirement of the method.

A method according to embodiments of the present invention may calculate regions by performing one or more line-scans, which may assure that every line of the screen may fit a region. Other methods may not guarantee this, as they may need a number of scales in advance.

Another method according to embodiments of the present invention may take advantage of additional information, for example from the cameras, e.g. calibration and/or ground plane, and may make some simplifications, e.g. detection of patches parallel to the screen, to create a parallelizable automatic method of object detection with a very low runtime, which may not be possible with any other known method. It may also have a high quality, e.g. based on a state of the art detection method.

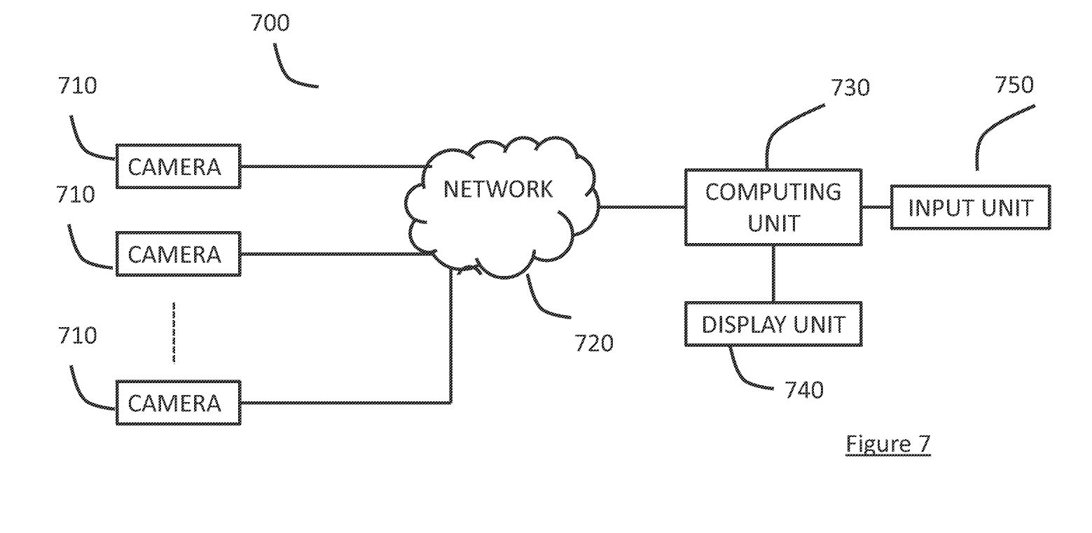

Reference is made to FIG. 7, which is an exemplary block diagram 700 according to embodiments of the present invention. One or more cameras 710 may be geo-spatially located among a geographic region. Cameras 710 may be operably connected to network 720, and may have ability of two-way communication or one-way from camera 710 to network 720. Communication between camera 710 and network 720 may be, for example by wired connection, by wireless connection, via an intermediary element or by any other operable connection. Communication between cameras 710 and network 720 may be real time or by storage and later transmission of information.

Computing unit 730 may be any suitable computer or computing device. Computing unit 730 may be used to execute any computations according to embodiments of the present invention. Computing unit 730 may be a stand-alone computing device or may be contained within other computing or multi-functional devices. Computing unit 730 may be operably connected to cameras 710 and network 720, where such connection may be wired, wireless or any other operably connection.

Display unit 740 may be operably connected to computing unit 730, network 720 and cameras 710. Display unit 740 may be configured to display to a user of a system according to embodiments of the present invention any outputs or video streams that such system may generate. Display unit 740 may also be used by a user to locate input commands, directions or selections into a system according to embodiments of the present invention. Objects or vehicles that may be monitored or observed according to embodiments of the present invention may be provided via display unit 740. Display unit 740 may be configured to display one or more video frames which may be received from one or more cameras 710. A graphics processing unit (GPU) may be located within computing unit 730, or may be operably connected to computing unit 730 and/or network 720.

Input unit 750 may be operably connected to computing unit 730, network 720 and cameras 710. Input unit 750 may be configured to accept an input from a user, for example to select one or more objects, e.g. vehicles, to initialize video-based object tracking. Input unit 750 may be used in conjunction with display unit 740 for selection of a target object within one or more video frames. In some embodiments, input unit 750 and display unit 740 may be a same device.

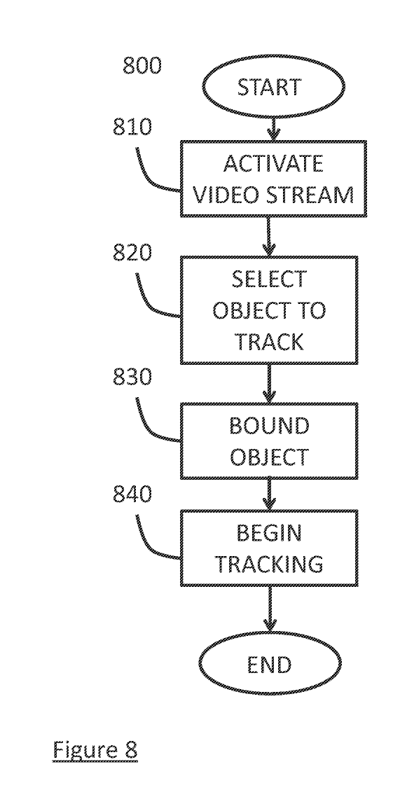

Reference is made to FIG. 8, which is an exemplary method 800 for initializing a video-based object tracking system according to embodiments of the present invention. A process begins and a video stream is activated 810. An object may be selected to track 820. Selection may be performed by various methods, for example by a user using a peripheral input device, e.g. a computer mouse, to select an object displayed by a display device, e.g. a computer monitor. An object selected may be bound 830 by a graphical or other bounding method, for example within one or more frames of a received video, e.g. from a camera.

Tracking of an object may begin 840, and may be based on the object selected, a computed bounding box and/or another visual identification from one or more video frames. A video based object tracking system may be initialized by a user input, and may begin a visual tracking algorithm on an object. Tracking of an object may begin following successful detection of such object.

An embodiment may be a method for reliably detecting an object in a video frame that may comprise predetermining one or more trained object classifiers based on one or more samples of a predetermined size, receiving a video stream from a camera, selecting an object within at least one frame of the video stream, determining a bound of the object based on the predetermined trained object classifiers, and detecting the object based at least on the bound. The objects may be vehicles. The object classifiers may be linear histogram of oriented gradients classifiers, and each may be based on histogram of oriented gradients feature vectors. Determining of the bound of the objects may be based on multi-scale single pass sliding window histogram of oriented gradients linear support vector machine classifiers. A calibration may be predetermined and may be based on the trained object classifiers, and performing a multi-scale single pass sliding window may also be based on such calibration. The object classifiers may be trained for the same object or object category for a plurality of grid sizes, and such object classifiers may be trained with positive and negative histogram of oriented gradients feature vector samples that may be extracted from a plurality of predetermined video image samples. A calibration may also determine a histogram of oriented gradients feature vectors by: dividing at least one video frame into a grid of cells, calculating a fixed size histogram of oriented gradients descriptor for each grid cell, and concatenating rows of histogram of oriented gradients descriptor cells to obtain a final histogram of oriented gradients descriptor of histogram of oriented gradients feature vectors. Object classifiers may be supported by vector machine classifiers, and such support vector machine classifiers may be trained for a plurality of grid sizes. At least one frame of the video stream may be rotated to orient a ground plane parallel to the horizontal orientation of the frame from the video stream It may be divided into cells, calculating histogram of oriented gradients features for each cell, calculating the corresponding representative size of each cell based on the projection onto the ground plan of at least two points within the border of the cell, using the Euclidean distance between these at least two points and a correlation with predetermined trained classifiers to determine the grid size to detect an object based on a representative size of each cell. Detecting an object may also comprises performing sliding window detection with a different window size for each row of grid cells, and each window size may be based on an object classifier. At least one frame of the video stream may be divided into regions, and dividing into said regions may be performed by line scanning of at least one frame of the video stream from the bottom to the top, reducing each image part when the required grid size for any one line is larger than a maximum size of trained object classifiers and fitting all the grid lines above the first line scan into the scaled remaining part of the frame of the video stream. Line scanning may also occur in other orders, e.g. from the top to the bottom, etc. Objects that may be detected may then be visually tracked.

Embodiments may be used as a method to initiate any tracking algorithm that may require a bounding box on an image to be initialized, for example when there may be calibration for a video stream being shown. It may be used to detect all types, or many types, of objects, e.g. if trained properly, reliably and in real time, using calibrated cameras.

Such an approach may be highly relevant for certain projects, e.g. the CITY project and the Video Analytics solutions of SafeCity. A deployed system in CITY may contain several thousand cameras. Object detection solutions may be highly relevant. Embodiments of the present invention may be immediately relevant, e.g. for the Vehicle Tracking functionality currently developed with the AVTS team.

Embodiments of the present invention may either be sold to authorities or companies that own, e.g. large scale, surveillance systems or may be used as part of other solutions. Other embodiments of the present invention may be an integral part of the developed Automatic Vehicle Tracking System. Regarding automatic vehicle tracking, the present invention may be directly applicable. It may be used for other kinds of Video Analytics Solutions, for example for environmental conditions the algorithm may be adapted, or partially adapted.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for reliably detecting an object in a video frame comprising:
predetermining one or more trained object classifiers based on one or more samples of predetermined size;
receiving a video stream from a camera;
selecting an object within at least one frame of said video stream;
determining a bound of said object based on said predetermined trained object classifiers; and
detecting said object based on said bound.

2. The method of claim 1, wherein said objects are vehicles.

3. The method of claim 1, wherein said object classifiers are linear histogram of oriented gradients classifiers, each based on histogram of oriented gradients feature vectors.

4. The method of claim 3 further comprising determining said bound of said object based on multi-scale single pass sliding window histogram of oriented gradients linear support vector machine classifiers.

5. The method of claim 4, further comprising predetermining a calibration based on said trained object classifiers, and performing said multi-scale single pass sliding window based on said calibration.

6. The method of claim 5, wherein said object classifiers are trained for the same object or object category for a plurality of grid sizes, and said object classifiers are trained with positive and negative histogram of oriented gradients feature vector samples extracted from a plurality of predetermined video image samples.

7. The method of claim 6, wherein said calibration further comprises determining said histogram of oriented gradients feature vectors by: dividing said at least one frame into a grid of cells; calculating a fixed size histogram of oriented gradients descriptor for each said grid cell; and concatenating rows of said histogram of oriented gradients descriptor cells to obtain a final histogram of oriented gradients descriptor of histogram of oriented gradients feature vectors.

8. The method of claim 7, wherein said object classifiers are support vector machine classifiers, and said support vector machine classifiers are trained for a plurality of grid sizes.

9. The method of claim 8, further comprising rotating the at least one frame of said video stream to orient the ground plane parallel to the horizontal orientation of said at least one frame of said video stream; dividing said at least one frame of said video stream into cells, calculating histogram of oriented gradients features for each cell; calculating the corresponding representative size of each cell based on the projection onto the ground plan of at least two points within the border of the cell, the Euclidean distance between said at least two points and a correlation with said predetermined trained classifiers; and determining the grid size to detect said object based on said representative size of each cell.

10. The method of claim 9, wherein detecting said object further comprises performing sliding window detection with a different window size for each row of said grid cells, and each said window size is based on a said object classifier.

11. The method of claim 10, further comprising dividing said at least one frame of said video stream into regions, wherein said dividing into said regions is performed by line scanning said at least one frame of said video stream from the bottom to the top, reducing each image part when the required grid size for any one line is larger than a maximum size of said trained object classifiers and fitting all the grid lines above the first said line scan into the scaled remaining part of said at least one frame of said video stream.

12. The method of claim 1, wherein said detected objects are visually tracked.

13. A system for reliably detecting an object in a video frame comprising:
a camera for receiving a video stream;
a display unit for displaying said video stream;
an input unit for selecting an object within at least one frame of said video stream;
a computing unit for predetermining one or more trained object classifiers based on one or more samples of predetermined size, determining a bound of said object based on said predetermined trained object classifiers and detecting said object based on said bound; and
a network operably connected to said camera, said display unit, said input unit and said computing unit.

14. The system of claim 13, wherein said objects are vehicles.

15. The system of claim 13, further comprising determining said bound of said object based on multi-scale single pass sliding window histogram of oriented gradients linear support vector machine classifiers; and predetermining a calibration based on said trained object classifiers, and performing said multi-scale single pass sliding window based on said calibration; wherein said object classifiers are linear histogram of oriented gradients classifiers, each based on histogram of oriented gradients feature vectors.

16. The system of claim 15, wherein said object classifiers are trained for the same object or object category for a plurality of grid sizes, and said object classifiers are trained with positive and negative histogram of oriented gradients feature vector samples extracted from a plurality of predetermined video image samples.

17. The system of claim 16, wherein said calibration further comprises determining said histogram of oriented gradients feature vectors by: dividing said at least one frame into a grid of cells; calculating a fixed size histogram of oriented gradients descriptor for each said grid cell; and concatenating rows of said histogram of oriented gradients descriptor cells to obtain a final histogram of oriented gradients descriptor of histogram of oriented gradients feature vectors; and wherein said object classifiers are support vector machine classifiers, and said support vector machine classifiers are trained for a plurality of grid sizes.

18. The system of claim 17, further comprising rotating the at least one frame of said video stream to orient the ground plane parallel to the horizontal orientation of said at least one frame of said video stream; dividing said at least one frame of said video stream into cells, calculating histogram of oriented gradients features for each cell; calculating the corresponding representative size of each cell based on the projection onto the ground plan of at least two points within the border of the cell, the Euclidean distance between said at least two points and a correlation with said predetermined trained classifiers; and determining the grid size to detect said object based on said representative size of each cell.

19. The system of claim 18, wherein detecting said object further comprises performing sliding window detection with a different window size for each row of said grid cells, and each said window size is based on a said object classifier.

20. The system of claim 19, further comprising dividing said at least one frame of said video stream into regions, wherein said dividing into said regions is performed by line scanning said at least one frame of said video stream from the bottom to the top, reducing each image part when the required grid size for any one line is larger than a maximum size of said trained object classifiers and fitting all the grid lines above the first said line scan into the scaled remaining part of said at least one frame of said video stream.
